(19) United States
(12) Patent Application Publication
(10) Pub. No.: US 2010/0001981 A1
(43) Pub. Date: Jan. 7, 2010

(54) DOT-MATRIX DISPLAY DATA REFRESH VOLTAGE CHARGING CONTROL METHOD AND SYSTEM

(76) Inventors: Chun-Hsi Chen, Taipei (TW); Jean-Fu Kiang, Taipei (TW)

Correspondence Address: SCHMEISER, OLSEN & WATTS, 22 CENTURY HILL DRIVE, SUITE 302, LATHAM, NY, 12110, US

(21) Appl. No.: 12/167,444

(22) Filed: Jul. 3, 2008

(51) Int. Cl. G09G 5/00

(52) U.S. Cl. 345/211; 345/55; 345/92

(57) ABSTRACT

A dot-matrix display data refresh voltage charging control method and system is proposed, which is designed for integration to a dot-matrix display device, such as TFT-LCD (Thin Film Transistor Liquid Crystal Display), for controlling a data-refresh process on the dot-matrix display device. The proposed method and system is characterized by the capability of performing data refresh by comparing for the differences between the currently-displayed pixel values and the new pixel values to be used for data refresh to thereby obtain a set of differential voltages for use to be applied to the pixels for data refresh. This feature allows the data-refresh process to use only a low level of differential voltage rather than the full-level of pixel data voltage for data refresh, thus allowing the data-refresh process to be completed in a reduced shorter time period to provide a fast scan speed.

### BACKGROUND OF THE INVENTION

1. Field of the Invention

This invention relates to dot-matrix display technology, and more particularly, to a dot-matrix display data refresh voltage charging control method and system which is designed for integration to a dot-matrix display device, such as TFT-LCD (Thin Film Transistor Liquid Crystal Display), for controlling a data-refresh process on the dot-matrix display device.

2. Description of Related Art

TFT-LCD (Thin Film Transistor Liquid Crystal Display) is a widely used dot-matrix display technology on electronic devices with a screen display such as notebook computers and intelligent mobile phones. In practice, a TFT-LCD device is equipped with an N×M dot-matrix panel which is an array of N rows and M columns of pixels, wherein each pixel is capable of displaying a particular color value in response to the charging of a particular level of data voltage thereto.

With technological advance, dot-matrix display devices have evolved from the early 640×480 resolution to modern high-definition resolutions such as 1920×1080 or higher. However, due to the increase in th-e amount of pixels, one important issue in the design of high-definition dot-matrix display devices is that the data-refresh process should be made much faster in order to maintain a fast scan speed for real-time display of video data. However, a fast scan speed means that the data voltage charging action on each pixel should be completed in a very short time period, which would undesirably cause the problem of insufficient charging.

In view of the foregoing issues in the design of dot-matrix display devices, there exists therefore a need in the electronic and computer industry for a new and improved dot-matrix display technology that allows the data refresh action on each pixel to be completed in a reduced shorter time for providing a fast scan speed.

### SUMMARY OF THE INVENTION

It is therefore an objective of this invention to provide a dot-matrix display data refresh voltage charging control method and system that allows the data refresh action on the pixels of a dot-matrix display device to be completed in a reduced shorter time for providing a fast scan speed.

The dot-matrix display data refresh voltage charging control method according to the invention comprises: (M1) when the dot-matrix display device displays a video frame on the dot-matrix panel, caching a duplicated copy of the currently-displayed video frame in a cache module; (M2) sequentially outputting a scan signal to each of the pixel rows of the dot-matrix display device for activating each pixel row into charging-enabled state; (M3) latching at least one pair of a new data row from a succeeding new video frame to be refreshed to the dot-matrix panel and an old data row from the video frame currently cached in the cache module during each scan period; (M4) converting each pixel in each latched new data row and each pixel in each latched old data row; and (M5) generating a set of charging voltages by comparing for the difference between the analog data voltage of each pixel in each new data row and the analog data voltage of each pixel in each new data row, and then outputting the charging voltages to the dot-matrix panel for date refresh of each pixel row of the dot-matrix panel.

In architecture, the dot-matrix display data refresh voltage charging control system according to the invention comprises two separate units: (A) a scan circuit; and (B) a data drive circuit; and wherein the data drive circuit includes: (B0) a video-frame cache module; (B1) a video-data latching module; (B2) a DAC array module; and (B3) a charging-voltage generating module.

The dot-matrix display data refresh voltage charging control method and system according to the invention is characterized by the capability of performing data refresh by comparing for the differences between the currently-displayed pixel values and the new pixel values to be used for data refresh to thereby obtain a set of differential voltages for use to be applied to the pixels for data refresh. This feature allows the data-refresh process to use only a low level of differential voltage rather than the full-level of pixel data voltage for data refresh, thus allowing the data-refresh process to be completed in a reduced shorter time period to provide a fast scan speed.

### BRIEF DESCRIPTION OF DRAWINGS

The invention can be more fully understood by reading the following detailed description of the preferred embodiments, with reference made to the accompanying drawings, wherein:

FIGS. 1A-1B are schematic diagrams showing the application of the dot-matrix display data refresh voltage charging control system of the invention with a dot-matrix display device;

FIG. 2 is a schematic diagram used to depict the writing of the digitized data of a video frame into a dot-matrix panel;

FIG. 3 is a schematic diagram showing the internal architecture of a data drive circuit constituting the invention;

FIGS. 4A-4C are schematic diagrams showing the internal circuit architecture of a charging-voltage generating module constituting the invention and the internal architecture of each individual charging-voltage generator constituting the charging-voltage generating module; and

FIG. 5 is a schematic diagram showing an exemplary implementation of the internal circuit architecture of the data drive circuit constituting the invention.

### DETAILED DESCRIPTION OF PREFERRED EMBODIMENTS

The dot-matrix display data refresh voltage charging control method and system according to the invention is disclosed in full details by way of preferred embodiments in the following with reference to the accompanying drawings.

### Function and Application of the Invention

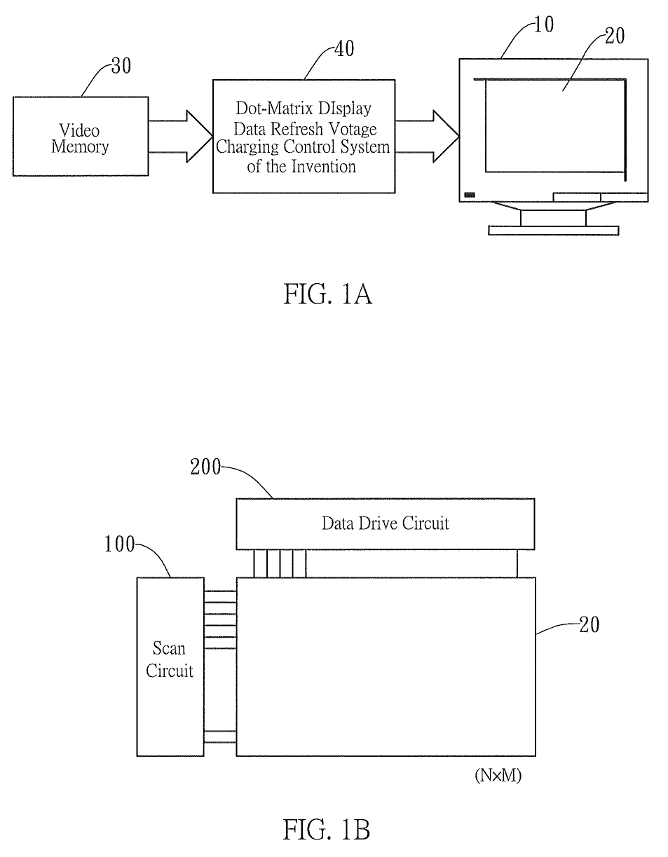

FIGS. 1A-1B are schematic diagrams showing the application of the dot-matrix display data refresh voltage charging control system of the invention (which is here encapsulated in a box indicated by the reference numeral 40, and is hereinafter referred in short as data refresh voltage charging control system). As shown, the data refresh voltage charging control system of the invention 40 is designed for integration to a dot-matrix display device 10, such as a TFT-LCD (Thin Film Transistor Liquid Crystal Display) device, that is equipped with an N×M dot-matrix panel 20 which is an array of N rows and M columns of pixels, and is further coupled to a video memory 30. In operation, the data refresh voltage charging control system of the invention 40 is capable of controlling a data-refresh process on the dot-matrix display device 10 for the purpose of displaying a sequence of video frames stored in the video memory 30 on the dot-matrix panel 20.

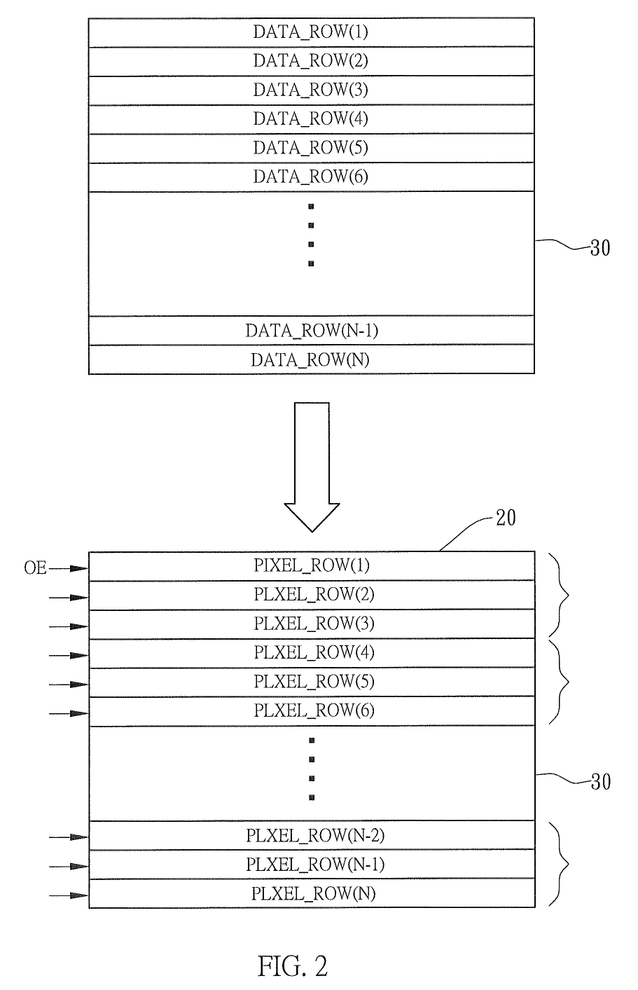

As shown in FIG. 2, the N×M dot-matrix panel 20 is composed of N pixel rows, which are respectively expressed as PIXEL_ROW(1), PIXEL_ROW(2) . . . , and PIXEL_ROW(N), wherein each pixel row contains M pixels. On the other hand, the video memory 30 is used to store the digitized data of a sequence of video frames that are to be displayed on the dot-matrix panel 20, wherein each video frame is composed of N rows of pixel data, which are respectively expressed as DATA_ROW(1), DATA_ROW(2), . . . , and DATA_ROW(N), and wherein each data row contains M pixels of data, and each pixel of data represents a color value that is to be displayed on the corresponding pixel on the dot-matrix panel 20.

In operation, the data refresh voltage charging control system of the invention 40 is used to write the data rows [DATA_ROW(1), DATA_ROW(2), . . . , DATA_ROW(N)] of each video frame in the form of analog data voltages to corresponding pixel rows in the dot-matrix display device 10; i.e., the first data row DATA_ROW(1) is to be written to the first pixel row PIXEL_ROW(1), the second data row DATA_ROW(2) is to be written to the second pixel row PIXEL_ROW(2), the third data row DATA_ROW(3) is to be written to the third pixel row PIXEL_ROW(3), and so forth.

### Architecture of the Invention

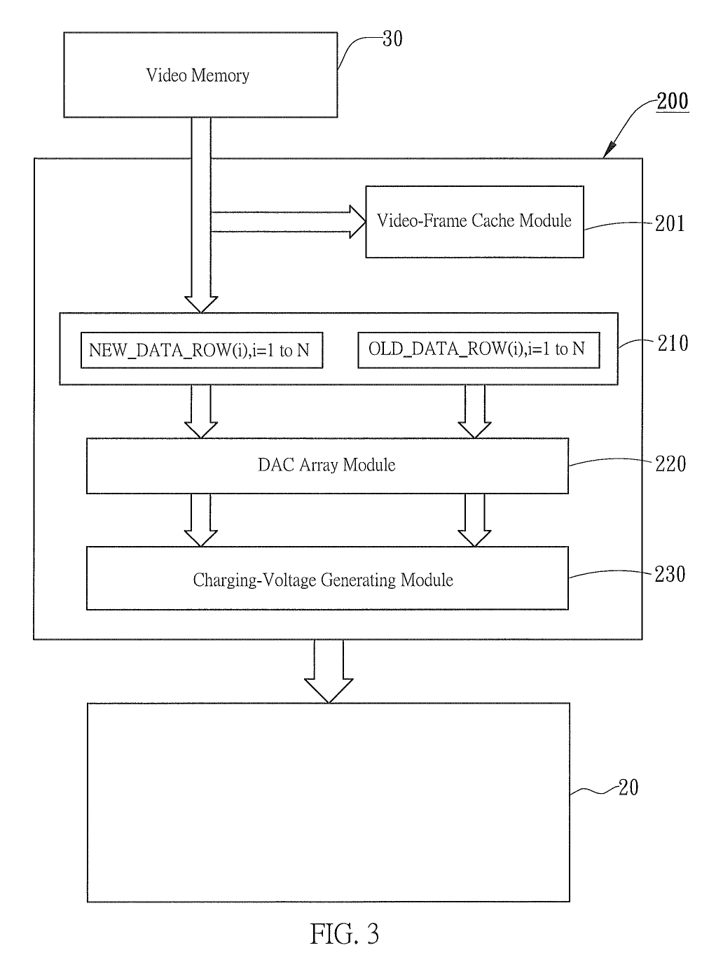

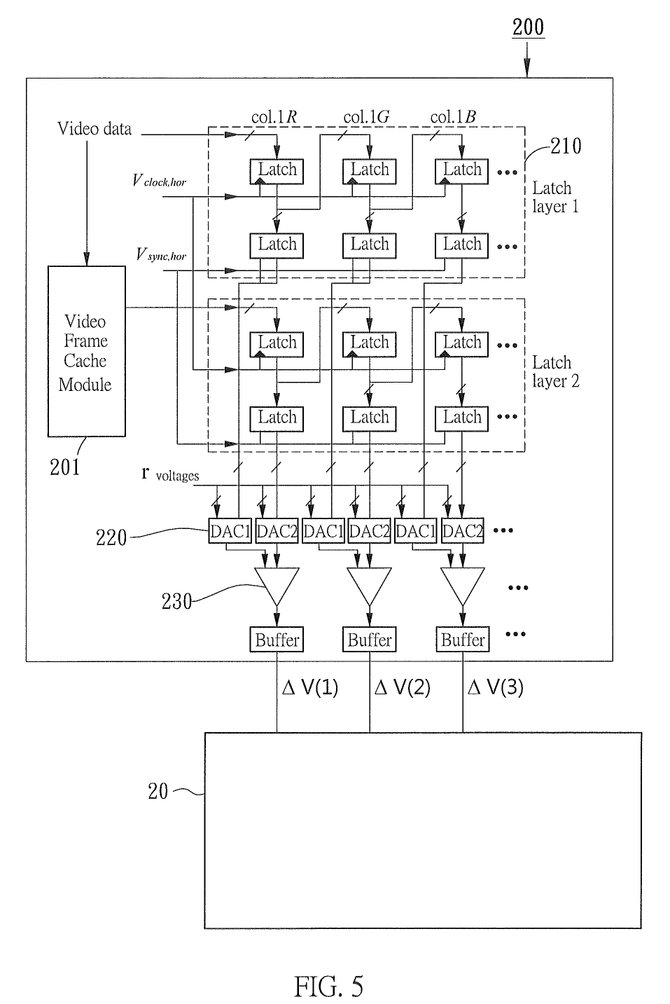

As shown in FIG. 1B, in architecture, the data refresh voltage charging control system of the invention 40 comprises two separate units: (A) a scan circuit 100; and (B) a data drive circuit 200; and as shown in FIG. 3 and FIG. 5, the data drive circuit 200 includes: (B0) a video-frame cache module 201; (B1) a video-data latching module 210; (B2) a digital-to-analog converter (DAC) array module 220; and (B3) a charging-voltage generating module 230. Firstly, the respective attributes and functions of these constituent components of the invention are described in details in the following.

### Scan Circuit 100

The scan circuit 100 is capable of periodically generating a scan signal OE with a predefined scan period T_{scan}, and outputting the scan signal OE in a sequential manner to each of the pixel rows of the dot-matrix panel 20 for activating each pixel row into charging-enabled state. In operation, during the first scan period T_{scan}, the scan signal OE is outputted to the first pixel row PIXEL_ROW(1) to activate all the pixels therein to charging-enabled state; and subsequently during the second scan period T_{scan}, the scan signal OE is outputted to the second pixel row PIXEL_ROW(2) to activate all the pixels therein to charging-enabled state; and so forth in a similar manner for all the succeeding pixel rows till PIXEL_ROW(N).

Since this scan circuit 100 is identical in function and internal architecture as those used in conventional dot-matrix display devices, detailed description thereof will not be given in this specification.

### Data Drive Circuit 200

As shown in FIG. 3 and FIG. 5, the internal architecture of the data drive circuit 200 includes: (B0) a video-frame cache module 201; (B1) a video-data latching module 210; (B2) a DAC array module 220; and (B3) a charging-voltage generating module 230. The respective attributes and functions of these constituent components 201, 210, 220, 230 of the data drive circuit 200 are described in details in the following.

### Video-Frame Cache Module 201

The video-frame cache module 201 is implemented with a memory unit, a data buffer, or any digital data storage medium, and is used for caching a duplicated copy of each video frame that is currently displayed on the dot-matrix panel 20. During data-refresh process, whenever the dot-matrix display device 10 displays a video frame on the dot-matrix panel 20, a duplicated copy of the currently-displayed video frame is temporarily stored in this video-frame cache module 201.

### Video-Data Latching Module 210

The video-data latching module 210 is activated during data refresh to each pixel row of the dot-matrix panel 20 for latching two data rows respectively from the currently-displayed video frame (hereinafter referred to as old video frame) and the succeeding video frame (hereinafter referred to as new video frame) that is to be refreshed to the dot-matrix panel 20. The data rows of the old video frame cached in the video-frame cache module 201 are expressed as [OLD_DATA_ROW(1), OLD_DATA_ROW(2), . . . , OLD_DATA_ROW(N)]), while those of the new video frame are expressed as [NEW_DATA_ROW(1), NEW_DATA_ROW(2), . . . ,NEW_DATA_ROW(N)]).

In each pass of data refresh, during the first scan period T_{scan}, the video-data latching module 210 is activated to read the first data row NEW_DATA_ROW(1) of the new video frame from the video memory 30, and concurrently read the first data row OLD_DATA_ROW(1) of the old video frame currently stored in the video-frame cache module 20 1. The new and old data rows [NEW_DATA_ROW(1), OLD_DATA_ROW(1)] are then latched side by side in the video-data latching module 210 to be used for date refresh of the first pixel row PIXEL_ROW(1) in the dot-matrix panel 20. Subsequently during the second scan period T_{scan}, the video-data latching module 210 is activated to read the second data row NEW_DATA_ROW(2) of the new video frame from the video memory 30, and concurrently read the second data row OLD_DATA_ROW(2) of the old video frame from the video-frame cache module 201. The new and old data rows [NEW_DATA_ROW(2), OLD_DATA_ROW(2)] are then latched side by side in the video-data latching module 210 to be used for date refresh of the second pixel row PIXEL_ROW(2) in the dot-matrix panel 20. The paired data latching action is repeated for all the rest of the new and old data rows during data refresh of each pixel row in the dot-matrix panel 20.

### DAC Array Module 220

The DAC array module 220 is composed of an array of digital-to-analog converters (DAC) which are used respectively for converting the digitized data of each pixel in each paired old data row and new data row latched in the data-latching module 210 into an analog data voltage. The output analog data voltages of the old data row and the output analog data voltages of the new data row are then transferred to the charging-voltage generating module 230 for further processing.

### Charging-Voltage Generating Module 230

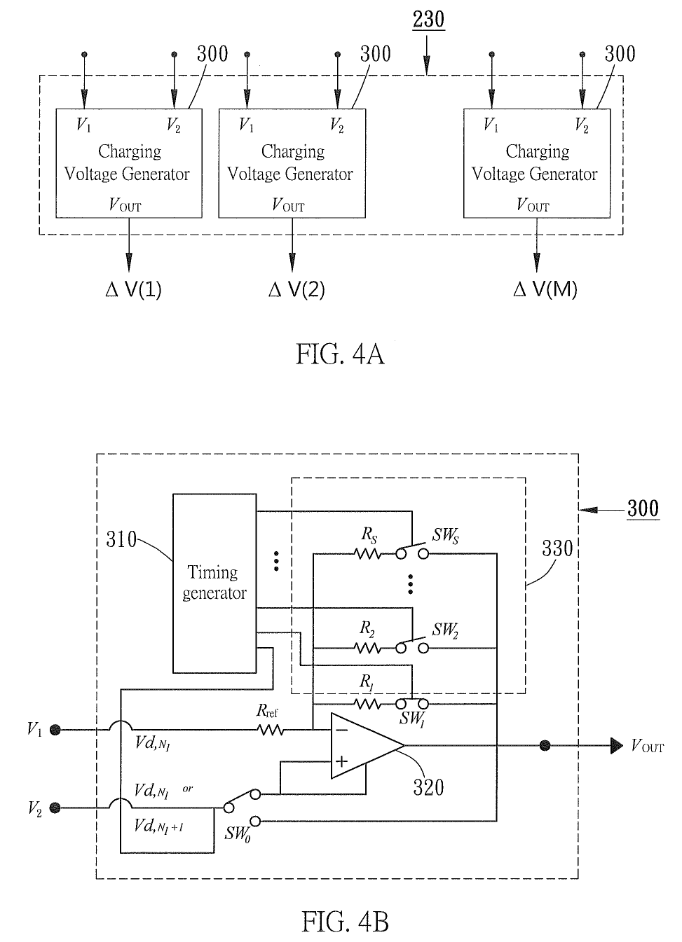

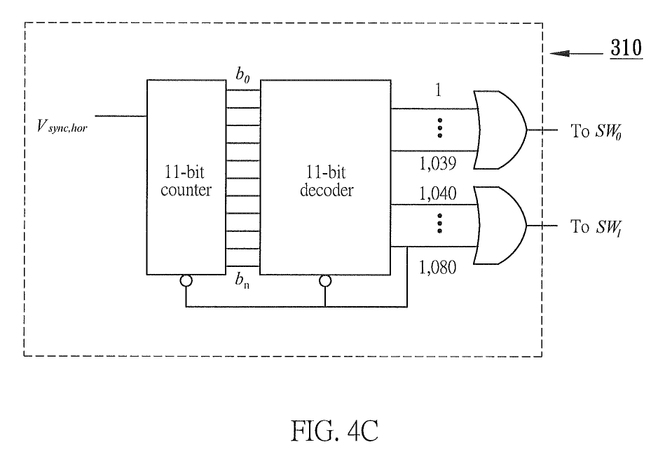

As shown in FIG. 4A, the charging-voltage generating module 230 is composed of an array of charging-voltage generators 3 00, each of which has two input ports (V₁, V₂) and an output port Vₒᵤₜ, and is used for generating a charging voltage by comparing for the difference between the data voltage of each pixel in each new data row and the data voltage of each corresponding pixel in the old data row, which are respectively received at the input ports (V₁, V₂). The resulted differential voltage is generated at the output port Vₒᵤₜ for use as the charging voltage to be applied to the pixels in the dot-matrix panel 20 for data refresh.

Taking the date refresh on the first pixel row PIXEL_ROW(1) as example, the scan circuit 100 is activated to output the first scan signal OE to PIXEL_ROW(1) during the first scan period T_{scan} to switch all pixels in PIXEL_ROW(1) to charging-enabled state. At the same time, the video-data latching module 210 is activated to read the first data row NEW_DATA_ROW(1) of the new video frame from the video memory 30, and concurrently read the first data row OLD_DATA_ROW(1) of the old video frame from the video-frame cache module 201. The paired new and old data rows [NEW_DATA_ROW(1), OLD_DATA_ROW(1)] are then latched side by side in the video-data latching module 210, and whereupon the M pixels in the new data row and the M pixels in the old data rows are all converted by the DAC array module 220 into analog data voltages. The M analog data voltages of the new data row and the M analog data voltages of the old data row are then respectively transferred in pair to the input ports (V₁, V₂) of each of the charging-voltage generators 300 in the charging-voltage generating module 230, where each pair of analog data voltages are compared to generate a set of M differential voltages [ΔV(1), ΔV(2), . . . , ΔV(M)], which are each generated at the output port V_{OUT} of each of the charging-voltage generators 300 for use as charging voltages to be applied to the pixels in PIXEL_ROW(1) for data refresh

If the color value of a certain pixel in the new data row NEW_DATA_ROW(1) is greater than that of the corresponding pixel of the same column in the old data row OLD_DATA_ROW(1), then the resultant charging voltage is positive in magnitude; whereas if smaller, the resultant charging voltage is negative in magnitude; and if equal, the resultant charging voltage is zero magnitude.

In practice, there are various different circuit architectures that can be used for implementation of the charging-voltage generators 300. In ideal case, the charging-voltage generators 300 can be each realized by using an analog voltage comparator which is simply used to implement Vₒᵤₜ=V₁−V₂. In practice, however, since the pixels in the dot-matrix panel 20 are located at different distances from the data drive circuit 200, a pixel located farther from the data drive circuit 200 should be connected to a lengthy bus line, which would undesirably cause the data transfer over this lengthy bus line to be subjected to a greater capacitive effect, thus resulting in a larger charging time constant that would cause a delay in the charging process. Therefore, for those pixels located farther from the data drive circuit 200, the charging voltages applied thereto should be correspondingly increased in magnitude. As a solution to this problem, the N pixel rows [PIXEL_ROW(1), PIXEL_ROW(2), . . . , PIXEL_ROW(N)] in the dot-matrix panel 20 are segmented into a number of subgroups, such as N/3 subgroups each including 3 consecutive pixel rows, and the charging time constant associated with the middle pixel row in each segmented subgroup is chosen as a common charging time constant for all of the pixel rows in that subgroup. In the case of 3-row subgroups, the total number of subgroups is N/3. The total number of subgroups can be further reduced by grouping those pixel rows whose charging time constants are approximately close or the same, which can help reduced the complexity of circuit implementation. The common charging time constant is then taken into consideration in the design of the charging-voltage generators 300 for adaptively adjusting the output charging voltages based on the segmented locations of the destination pixel rows. This type of charging-voltage generator 300 is hereinafter referred to as a row-segmentation adaptive charging-voltage generator. One example of such a row-segmentation adaptive charging-voltage generator 300 is shown in FIG. 4B, which includes a timing generator 310, an analog voltage comparator 320, and a resistor matrix 330. The internal circuit architecture of the timing generator 310 is shown in FIG. 4C. The operation of the row-segmentation adaptive charging-voltage generator 300 of FIG. 4B is sequentially controlled by the timing generator 310 to provide an adaptively-adjusted voltage output through the resistor matrix 330. The principle and circuit architecture of the row-segmentation adaptive charging-voltage generator is disclosed in the technical paper entitled “PRECISE CHARGING METHOD WITH MULTIPLE ROWS” and “ACTIVE AND ADAPTIVE CHARGING METHOD ON DATA LINES FOR DELAY COMPENSATION” by Chun-Hsi et al, so detailed description thereof will not be given in this specification.

It is to be noted that the realization of the row-segmentation adaptive type of charging-voltage generator 300 is not limited to the circuit architecture shown in FIGS. 4B-4C, and various other circuit architectures are possible.

Moreover, in the case that the dot-matrix display device 10 is constructed on a new technology that allows all the pixels to be equally distanced from the data drive circuit 200 (i.e., all pixels are associated with the same charging time constant), then the use of the row-segmentation adaptive charging-voltage generator will be unnecessary. In this case, the charging-voltage generators 300 can be simply realized by using a conventional analog voltage comparator.

### Operation of the Invention

The following is a detailed description of the operation of the data refresh voltage charging control system of the invention 40. During operation, the data refresh voltage charging control system of the invention 40 is responsible for controlling a data-refresh process on the dot-matrix panel 20.

During the operation of the dot-matrix display device 10, it will display a sequence of video frames successively on the dot-matrix panel 20. When one video frame is displayed on the dot-matrix panel 20, the data refresh voltage charging control system of the invention 40 will be activated to store a duplicated copy of the currently-displayed video frame into the video-frame cache module 201.

Subsequently, the dot-matrix display device 10 will perform a data-refresh process by writing a new data frame to the dot-matrix panel 20 to replace the old data frame. Firstly, the scan circuit 100 outputs the scan signal OE to the first pixel row PIXEL_ROW(1) in the dot-matrix panel 20 during the first scan period T_{scan} to switch all pixels in PIXEL_ROW(1) to charging-enabled state. At the same time, the video-data latching module 210 is activated to read the first data row NEW_DATA_ROW(1) of the new video frame from the video memory 30, and concurrently read the first data row OLD_DATA_ROW(1) of the old video frame from the video-frame cache module 201. The paired new and old data rows OLD_DATA_ROW(1), NEW_DATA_ROW(1) are then latched side by side in the video-data latching module 210, and whereupon the M pixels of OLD_DATA_ROW(1) and the M pixels of NEW_DATA_ROW(1) are all converted by the DAC array module 220 into analog data voltages, which are then respectively transferred to the input ports (V₁, V₂) of each of the charging-voltage generators 300 in the charging-voltage generating module 230, where each pair of analog data voltages are compared to generate a set of M differential voltages [ΔV(1), ΔV(2), . . . , ΔV(M)], which are each generated at the output port V_{OUT} of each of the charging-voltage generators 300 for use as charging voltages to be applied to the pixels of PIXEL_ROW(1).

If the color value of a certain pixel in NEW_DATA_ROW(1) is greater than that of the corresponding pixel of the same column in OLD_DATA_ROW(1), then the resultant charging voltage is positive in magnitude; whereas if smaller, the resultant charging voltage is negative in magnitude; and if equal, the resultant charging voltage is zero magnitude.

The M differential voltages [ΔV(1), ΔV(2), . . . , ΔV(M)] generated by the charging-voltage generating module 230 are then used as charging voltages and applied respectively to the M pixels of PIXEL_ROW(1). If the charging voltage applied to a certain pixel is positive, it implies that the new data to be used for refresh is greater in value than the old data; and therefore, the charging voltage will add more electrical charge to that pixel, thereby increasing the currently-charged data voltage to the intended level specified by the new video frame. On the other hand, if the charging voltage applied is negative, it implies that the new data to be used for refresh is smaller in value than the old data; and therefore, it will lower the currently-charged data voltage to the intended level specified by the new video frame.

After the date refresh on the first pixel row PIXEL_ROW(1) is completed, the scan circuit 100 outputs the scan signal OE to the second pixel row PIXEL_ROW(2) in the dot-matrix panel 20 during the second scan period T_{scan} to switch all pixels in PIXEL_ROW(2) to charging-enabled state. At the same time, the video-data latching module 210 is activated to read the second data row NEW_DATA_ROW(2) of the new video frame from the video memory 30, and concurrently read the second data row OLD_DATA_ROW(2) of the old video frame from the video-frame cache module 201. The same process is then repeated for data refresh of PIXEL_ROW(2) based on the paired new and old data rows [NEW_DATA_ROW(2), OLD_DATA_ROW(2)] latched in the video-data latching module 210.

The foregoing data-refresh process is repeated for all the rest of the pixel rows in the dot-matrix panel 20 until the last pixel row PIXEL_ROW(N) is data refreshed. Subsequently, the same data-refresh process is repeated again for the next video frame that is to be refreshed to the dot-matrix panel 20.

In conclusion, the invention provides a dot-matrix display data refresh voltage charging control method and system, which is characterized by the capability of performing data refresh by comparing for the differences between the currently-displayed pixel values and the new pixel values to be used for data refresh to thereby obtain a set of differential voltages for use to be applied to the pixels for data refresh. This feature allows the data-refresh process to use only a low level of differential voltage rather than the full-level of pixel data voltage for data refresh, thus allowing the data-refresh process to be completed in a reduced shorter time period to provide a fast scan speed. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A dot-matrix display data refresh voltage charging control method for use on a dot-matrix display device for providing a;
the dot-matrix display data refresh voltage charging control method comprising:
when the dot-matrix display device displays a video frame on the dot-matrix panel, caching a duplicated copy of the currently-displayed video frame in a cache module;
sequentially outputting a scan signal to each of the pixel rows of the dot-matrix display device for activating each pixel row into charging-enabled state;
latching at least one pair of a new data row from a succeeding new video frame to be refreshed to the dot-matrix panel and an old data row from the video frame currently cached in the cache module during each scan period;
converting each pixel in each latched new data row and each pixel in each latched old data row; and
generating a set of charging voltages by comparing for the difference between the analog data voltage of each pixel in each new data row and the analog data voltage of each pixel in each new data row, and then outputting the charging voltages to the dot-matrix panel for date refresh of each pixel row of the dot-matrix panel.

2. The dot-matrix display data refresh voltage charging control method of claim 1, wherein the dot-matrix display device is a TFT-LCD (Thin Film Transistor Liquid Crystal Display) device.

3. The dot-matrix display data refresh voltage charging control method of claim 1, wherein the generation of the charging voltages is based on a row-segmentation adaptive scheme that is capable of adaptively adjusting the generated charging voltages based on different charging time constants associated with the pixel rows of the dot-matrix panel

4. A dot-matrix display data refresh voltage charging control system for integration to a dot-matrix display device equipped with a dot-matrix panel and a video memory for controlling a data-refresh process on the dot-matrix display device;
the dot-matrix display data refresh voltage charging control system comprising:
a scan circuit, which is capable of periodically generating a scan signal and outputting the scan signal in a sequential manner to each of the pixel rows of the dot-matrix display device for activating each pixel row into charging-enabled state; and
a data drive circuit, which includes:
a video-frame cache module, which is used for caching a duplicated copy of a video frame that is currently displayed on the dot-matrix panel;
a video-data latching module, which is capable of latching at least one pair of a new data row from a succeeding new video frame to be refreshed to the dot-matrix panel and an old data row from the video frame currently stored in the video-frame cache module;
a digital-to-analog converter array module, which is capable of converting each pixel in each new data row and each pixel in each old data row that are currently latched in the video-data latching module into an analog data voltage; and
a charging-voltage generating module, which is capable of generating a set of charging voltages by comparing for the difference between the analog data voltage of each pixel in each new data row and the analog data voltage of each pixel in each new data row, and which is further capable of outputting the charging voltages to the dot-matrix panel for date refresh of each pixel row of the dot-matrix panel.

5. The dot-matrix display data refresh voltage charging control system of claim 4, wherein the dot-matrix display device is a TFT-LCD (Thin Film Transistor Liquid Crystal Display) device.

6. The dot-matrix display data refresh voltage charging control system of claim 4, wherein the charging-voltage generating module includes an array of charging-voltage generators, each of which is implemented with an analog voltage comparator.

7. The dot-matrix display data refresh voltage charging control system of claim 4, wherein the charging-voltage voltage generating module includes an array of charging-voltage generators, each of which is implemented with a row-segmentation adaptive differential voltage generator that is capable of adaptively adjusting the charging voltages based on different charging time constants associated with the pixel rows of the dot-matrix panel.
